(19) United States
(12) Patent Application Publication
(10) Pub. No.: US 2010/0110021 A1
(43) Pub. Date: May 6, 2010

(54) ELECTRONIC DEVICE EQUIPPED WITH INTERACTIVE DISPLAY SCREEN AND PROCESSING METHOD FOR INTERACTIVE DISPLAYING

(75) Inventors: Chia-Chang Chiu, Hsinchu (TW); Cheng-Liang Huang, Hsinchu (TW)

Correspondence Address: APEX JURIS, PLLC, 12733 LAKE CITY WAY NORTHEAST, SEATTLE, WA, 98125, US

(73) Assignee: MITAC TECHNOLOGY CORP., Hsinchu (TW)

(21) Appl. No.: 12/266,502

(22) Filed: Nov. 6, 2008

(51) Int. Cl. G06F 3/041; G06F 3/033

(52) U.S. Cl. 345/173; 345/179

(57) ABSTRACT

A processing method for interactive displaying is provided and applied to an electronic device equipped with an interactive display screen. The display screen includes an up-down stacked digitizer board and a touch panel. The processing method for interactive displaying includes the following steps: determining whether the digitizer board senses existence of a digitizer pen; and when the digitizer board senses existence of the digitizer pen, performing a first designate operation on the touch panel.

### BACKGROUND OF THE INVENTION

1. Field of the Invention

The present invention relates to an electronic device, and more particularly, to an electronic device equipped with an interactive display screen that includes both a digitizer board and a touch panel, and a processing method for interactive displaying.

2. Related Art

Nowadays, certain electronic systems are already equipped with a digitizer board and a touch panel that are integrated on a single display screen. Through electromagnetic sensing technology, a digitizer pen is adapted to be used for click-to-select control or information input without completely contacting with the display screen; the digitizer pen can even input information through directly writing on the display screen, such as signing a signature or drawing a picture. On the other hand, the user may optionally use an object (like a finger) to achieve the functions of click-to-select control or information input through direct contacting the touch panel.

However, when the integrated digitizer board and touch panel are both under operation and a digitizer pen touches the display screen, each of the digitizer board and the touch panel will respectively sense and receive the touch control signals at the same time. Through the digitizer board and the touch panel, the touch control signals will all be sent back to the operating system of the electronic device; yet these touch control signals from different processes will cause shaking behaviors or abnormal actions of the cursor, which are misinterpreted by the electronic device as “double click” operations.

Aiming at the problem, an external hardware switch button is designed for the user to manually press and switch between the digitizer board mode and the touch panel mode. Such function is however not quite convenient. The user has to figure out first what the current mode is, otherwise the user is reminded and realizes the switch button should be pressed and switched first only when the touch-control operation is abnormal. It is common for new users to be completely not aware that the switch button needs to be pressed to switch between different operation modes.

### SUMMARY OF THE INVENTION

To solve the aforesaid problems of the prior art, the present invention provides an electronic device equipped with an interactive display screen, and a processing method for interactive displaying. The present invention automatically controls and switches between a digitizer board and a touch panel, thereby saves the cost of an external hardware switch button and prevents the digitizer board and the touch panel from generating different input signals corresponding to the same touch behavior.

In an embodiment of the present invention, an electronic device comprises an interactive display screen, an automatic switch unit, and a system host. The interactive display screen has a digitizer board, a display panel and a touch panel up-down stacked with each other. The automatic switch unit is in electrical connection with the digitizer board and the touch panel. The automatic switch unit conducts a first designate operation on the touch panel when the digitizer board senses existence of a corresponding digitizer pen. The system host is in circuit connection with the automatic switch unit and with the display panel, so that through the automatic switch unit, the system host indirectly receives inputs from the digitizer board or the touch panel and correspondingly controls the display panel for interactive displaying.

In another embodiment of the present invention, a processing method is adapted to an electronic device equipped with an interactive display screen. The interactive display screen has a digitizer board, a display panel and a touch panel up-down stacked with each other. The processing method comprising the following steps. First of all, determine whether the digitizer board senses existence of a digitizer pen. And afterwards, automatically conduct a first designate operation on the touch panel when the digitizer board senses existence of the digitizer pen.

These and other features, aspects, and advantages of the present invention will become better understood with reference to the following description and appended claims. It is to be understood that both the foregoing general description and the following detailed description are examples, and are intended to provide further explanation of the invention as claimed.

### BRIEF DESCRIPTION OF THE DRAWINGS

The present invention will become more fully understood from the detailed description given herein below for illustration only, and thus is not limitative of the present invention, and wherein:

FIG. 1 is a schematic view of a electronic device according to the present invention;

FIG. 2 is a flow chart of an processing method for interactive displaying according to the present invention;

FIG. 3 is a flow chart of another processing method for interactive displaying according to another embodiment of the present invention; and

FIG. 4 is a flow chart of another processing method for interactive displaying according to another embodiment of the present invention.

### DETAILED DESCRIPTION OF THE INVENTION

Reference will now be made in detail to the present preferred embodiments of the invention, examples of which are illustrated in the accompanying drawings. Wherever possible, the same reference numbers are used in the drawings and the description refers to the same or the like parts.

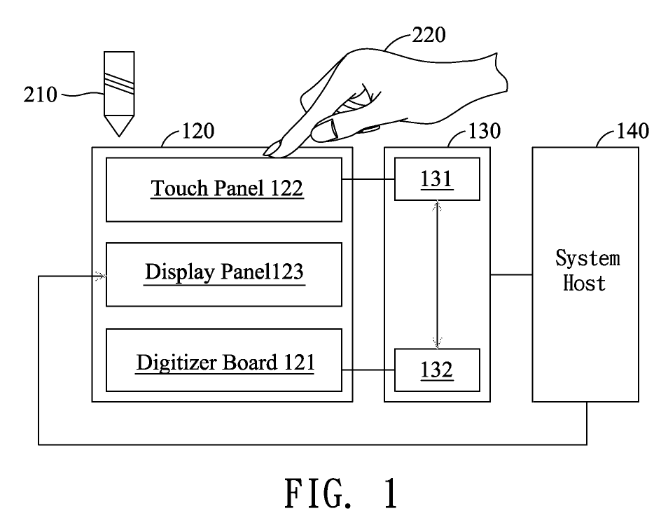

FIG. 1 is a schematic view of an electronic device according to the present invention. As shown in the drawing, the electronic device includes an interactive display screen 120, an automatic switch unit 130 and a system host 140. The interactive display screen 120 includes a digitizer board 121, a touch panel 122 and a display panel 123 up-down stacked with each other. The system host 140 at least includes a central processor unit, a system memory, one or more bridge chipset and multiple system buses for internal communications of the electronic device. The system host 140 is in circuit connection with the automatic switch unit 130 and with the display panel 123, so that the system host 140 indirectly receives inputs from the digitizer board 121 or the touch panel 122 and correspondingly controls the display panel 123 for interactive displaying, such as controls a cursor (not shown) of the electronic device to be interactively displayed on the display panel 123.

The digitizer board 121 is configured at the bottom section of the display panel 123. Through electromagnetic sensing, the digitizer board 121 senses the changes of the magnetic field of sensing coils equipped inside the digitizer pen 210 so as to generate corresponding signals, as long as the distance between the digitizer pen 210 and the digitizer board 121 is smaller than a predetermined value.

The touch panel 122 is configured at the top section of the display panel 123. The touch panel 122 may be realized by a resistive touch panel, a capacitive touch panel or an optical touch panel. When the object 220 contacts the touch panel 122, the touch panel 122 senses the contact behavior of the object 220 and then generates corresponding signals and send to the automatic switch unit 130.

The display panel 123 may be realized by various types of display panels that are capable of illustrating information thereon, such as a liquid crystal display (LCD) panel, an organic light-emitting diode (OLED) display panel, a light-emitting diode (LED) display panel and etc. Since the structures and operation principles of the digitizer board 121, the display panel 123, and the touch panel 122 are well known to those skilled in the art, the technology details will not be further described or explained hereinafter.

The automatic switch unit 130 is in electrical connection with the digitizer board 121 and the touch panel 122. In an embodiment of the present invention, the automatic switch unit 130 may include a touch-panel control unit 131 and a digitizer-board control unit 132. The touch-panel control unit 131 is in circuit connection with the touch panel 122; the digitizer-board control unit 132 is similarly in circuit connection with the digitizer board 121. The display panel 123 is in circuit connection with the system host 140 and displays according to the commands from the system host 140. The automatic switch unit 130 switches between the digitizer board 121 and the touch panel 122 according to the statuses of the digitizer board 121 and the touch panel 122. And then the automatic switch unit 130 transmits only the signals whenever sent from one of the digitizer board 121 and the touch panel 122 to the system host 140, so that the cursor can be displayed on the display panel 123 and controlled by the signals sent from either the digitizer board 121 or the touch panel 122.

The touch-panel control unit 131 actuates and controls the touch panel 122. The digitizer-board control unit 132 actuates and controls the digitizer board 121. The touch-panel control unit 131 and digitizer-board control unit 132 may communicate with each other through bidirectional communications, or through issuing direct/indirect signals to inform the other and conduct specific actions, so as to determine which signals (from the digitizer board 121 or the touch panel 122) should be processed and transmitted to the system host. The automatic switch unit 130 may be realized by an embedded controller, a glue logic or a filter circuit. When the digitizer board 121 senses existence of the digitizer pen 210, the automatic switch unit 130 conducts a first designate operation on the touch panel 122. In a practical embodiment, the first designate operation may be disabling the touch panel 122 (such as to cease the supply of the operation voltage to the touch panel 122). In other embodiment, the first designate operation may be: the automatic switch unit 130 ceases receiving the signals sent from the touch panel 122; or the automatic switch unit 130 ceases transmitting the signals sent from touch panel 122 to the system host 140.

When the digitizer board 121 does not sense existence of the digitizer pen 210, the automatic switch unit 130 ceases conducting the first designate operation on the touch panel 122. In a practical embodiment, when the digitizer board 121 does not sense existence of the digitizer pen 210, the automatic switch unit 130 will switch the touch panel 122 from a disabling state to an enabling state. In another practical embodiments, when the digitizer board 121 does not sense existence of the digitizer pen 210, plus the object 220 contacts the touch panel 122, the automatic switch unit 130 will switch the touch panel 122 from the disabling state to the enabling state.

Moreover, when the digitizer board 121 does not sense existence of the digitizer pen 210, the automatic switch unit 130 may conduct a second designate operation on the digitizer board 121. In a practical embodiment, the second designate operation is to make the digitizer board 121 continue to sense the digitizer pen 210. [symbol] another practical embodiment, the second designate operation is to disable the digitizer board 121. In another embodiment, the second designate operation is that: the automatic switch unit 130 ceases transmitting the signals sent from the digitizer board 121 to the system host 140; or the automatic switch unit 130 ceases receiving the signals sent from the digitizer board 121.

When the digitizer board 121 does not sense existence of the digitizer pen 210, plus the object 220 does not contact the touch panel 122 either, the automatic switch unit 130 may enable both of the digitizer board 121 and the touch panel 122. When the digitizer board 121 senses existence of the digitizer pen 210 or the object 220 contacts the touch panel 122, the automatic switch unit 130 will continue to enable one of the digitizer board 121 and the touch panel 122, and also conduct the one of the digitizer board 121 and the touch panel 122 into a specific state. For example, when the digitizer board 121 senses existence of the digitizer pen 210, the automatic switch unit 130 continues to enable the digitizer board 121, yet conducts the touch panel 122 into a disabling state, a standby state, a sleep state, a suspend state or a freeze state. When the digitizer board 121 does not sense existence of the digitizer pen 210 any more, the automatic switch unit 130 will conduct the touch panel 122 to be released from the specific state. In another practical embodiment, only when the object 220 contacts the touch panel 122, will the touch panel 122 be released from the specific state.

Similarly, when the object 220 contacts the touch panel 122, the automatic switch unit 130 will continue to enable the touch panel 122 and conduct the digitizer board 121 into the specific state. In a practical embodiment, when the digitizer board 121 enters into the specific state, the digitizer board 121 can still senses existence of the digitizer pen 210 by remain its sensing function. In another practical embodiment, the digitizer board 121 may enter into a disabling state, a standby state, a sleep state, a suspend state or a freeze state. When the object 220 does not contact the touch panel 122 for a certain time period, the automatic switch unit 130 may conduct the digitizer board 121 to be released from the specific state. In another practical embodiment, only when the digitizer board 121 senses existence of the digitizer pen 210, will the digitizer board 121 be released from the specific state.

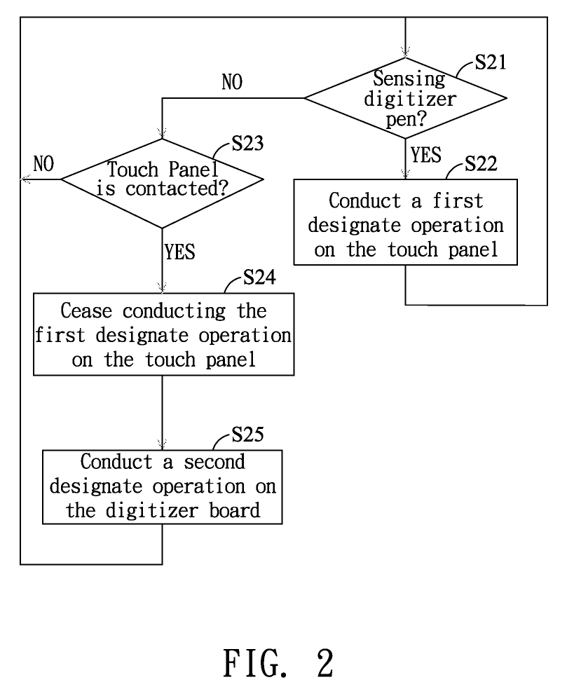

FIG. 2 is a flow chart of a processing method for interactive displaying according to the present invention. The processing method of the present invention is adapted to an electronic device that is equipped with an interactive display screen. The electronic device has a display screen that includes a digitizer board, a touch panel and a display panel up-down stacked with each other. Please also refer to aforesaid descriptions and the drawings regarding the electronic device.

First of all, determine whether the digitizer board senses existence of the digitizer pen (Step S21). When the digitizer board senses existence of the digitizer pen, conduct a first designate operation on the touch panel (Step S22). In a practical embodiment, the first designate operation is to disable the touch panel. In another practical embodiment, the first designate operation is to conduct the touch panel into a disabling state, a standby state, a sleep state, a suspend state or a freeze state. In another embodiment, the first designate operation is to cease processing or transmitting out the signals sent from the touch panel, or to cease receiving the signals sent from the touch panel.

After finishing the first designate operation, further determine whether the digitizer board senses existence of the digitizer pen (Step S21). If the digitizer board does not sense existence of the digitizer pen, determine whether the touch panel is contacted by an object (Step S23). When the touch panel is not contacted, return to Step S21. When the touch panel is contacted, cease conducting the first designate operation on the touch panel (Step S24). If the first designate operation is to disable the touch panel, Step S24 is to enable the touch panel.

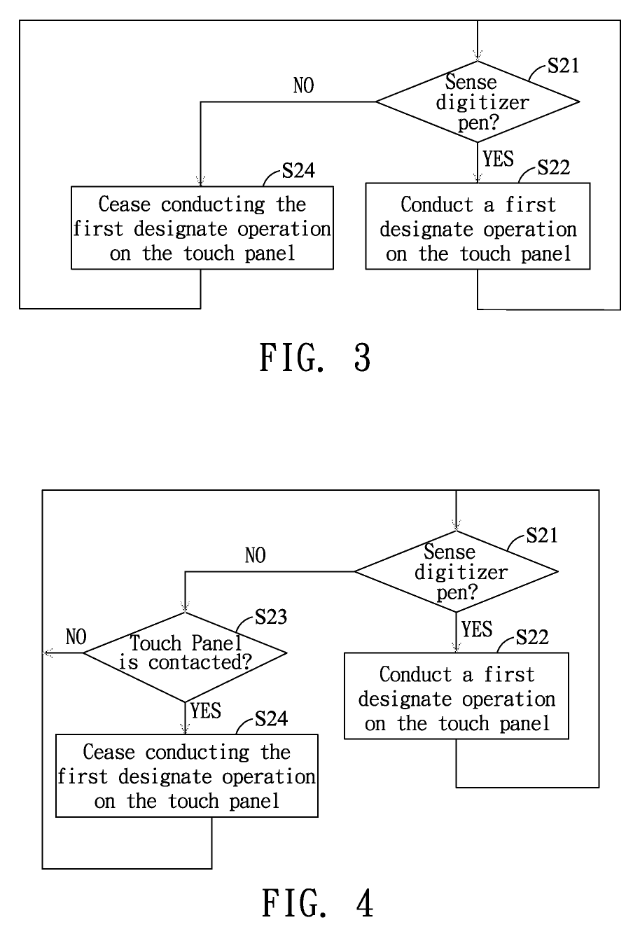

In another practical embodiment (such as what are shown in FIG. 3), Step S23 of FIG. 2 may be omitted. For example, as long as the digitizer board does not sense existence of the digitizer pen, cease conducting the first designate operation on the touch panel. In another practical embodiment, Step S24 is not necessary to be performed if Step S22 is not performed in advance.

Please refer to FIG. 2. When the digitizer board does not sense existence of the digitizer pen and the touch panel is contacted, conduct a second designate operation on the digitizer board (Step S25). In another practical embodiment (as shown in FIG. 4), Step S25 in FIG. 2 may be omitted; namely the digitizer board will not conduct any specific action/operation. Furthermore, in another embodiment the second designate operation is to keep the digitizer board sensing the digitizer pen. In another practical embodiment, the second designate operation is to conduct the digitizer board into a disabling state, a standby state, a sleep state, a suspend state or a freeze state. In another practical embodiment, the second designate operation is to cease processing or transmitting out the signals sent from the digitizer board, or to cease receiving the signals sent from the digitizer board

Through the automatic switch procedures of the processing method for interactive displaying in the present invention, no external hardware switch/button is required to be manually pressed by the user for switching between the two modes of the digitizer board or the touch panel. Besides, when the digitizer board senses existence of the digitizer pen, a specific action/operation will be conducted on the touch panel, thereby avoiding the digitizer board and the touch panel from processing a contact behavior in parallel and causing shaking behaviors or abnormal actions of the cursor.

Additional advantages and modifications will readily occur to those proficient in the relevant fields. The invention in its broader aspects is therefore not limited to the specific details and representative embodiments shown and described herein. Accordingly, various modifications may be made without departing from the spirit or scope of the general inventive concept as defined by the appended claims and their equivalents.

What is claimed is:

1. An electronic device, comprising:
an interactive display screen, having a digitizer board, a display panel and a touch panel up-down stacked with each other;
an automatic switch unit, being in electrical connection with the digitizer board and the touch panel, the automatic switch unit conducting a first designate operation on the touch panel when the digitizer board senses existence of a corresponding digitizer pen; and
a system host being in circuit connection with the automatic switch unit and with the display panel, so that through the automatic switch unit, the system host indirectly receives inputs from the digitizer board or the touch panel and correspondingly controls the display panel for interactive displaying.

2. The electronic device as claimed in claim 1, wherein the automatic switch unit ceases conducting the first designate operation on the touch panel when the digitizer board does not sense existence of the digitizer pen.

3. The electronic device as claimed in claim 1, wherein the automatic switch unit ceases conducting the first designate operation on the touch panel when the digitizer board does not sense existence of the digitizer pen and also the touch panel is contacted.

4. The electronic device as claimed in claim 2, wherein the first designate operation is to disable the touch panel.

5. The electronic device as claimed in claim 2, wherein the first designate operation is to cease processing/receiving a signal from the touch panel.

6. The electronic device as claimed in claim 2, wherein the automatic switch unit conducts a second designate operation on the digitizer board when the digitizer board does not sense existence of the digitizer pen.

7. The electronic device as claimed in claim 6, wherein the second designate operation is to keep the digitizer board sensing the digitizer pen.

8. The electronic device as claimed in claim 6, wherein the second designate operation is to disable the digitizer board.

9. The electronic device as claimed in claim 6, wherein the second designate operation is to cease processing/receiving a signal sent from the digitizer board.

10. The electronic device as claimed in claim 6, wherein the automatic switch unit includes a touch-panel control unit and a digitizer-board control unit, the touch-panel control unit actuating and controlling the touch panel, the digitizer-board control unit actuating and controlling the digitizer board, the touch-panel control unit and the digitizer-board control unit communicating with each other to determine which signals sent from the digitizer board or the touch panel should be processed.

11. A processing method adapted to an electronic device equipped with an interactive display screen, the interactive display screen having a digitizer board, a display panel and a touch panel up-down stacked with each other, the processing method comprising the steps of:
determining whether the digitizer board senses existence of a digitizer pen; and
automatically conducting a first designate operation on the touch panel when the digitizer board senses existence of the digitizer pen.

12. The processing method as claimed in claim 11 further comprising a step of ceasing conducting the first designate operation on the touch panel when the digitizer board does not sense existence of the digitizer pen.

13. The processing method as claimed in claim 12 further comprising a step of ceasing conducting the first designate operation on the touch panel when the digitizer board does not sense existence of the digitizer pen and also the touch panel is contacted.

14. The processing method as claimed in claim 12, wherein the first designate operation is to disable the touch panel.

15. The processing method as claimed in claim 12, wherein the first designate operation is to cease processing or receiving a signal sent from the touch panel.

16. The processing method as claimed in claim 12 further comprising a step of conducting a second designate operation on the digitizer board when the digitizer board does not sense existence of the digitizer pen.

17. The processing method as claimed in claim 16, wherein the second designate operation is to keep the digitizer board sensing the digitizer pen.

18. The processing method as claimed in claim 16, wherein the second designate operation is to disable the digitizer board.

19. The processing method as claimed in claim 16, wherein the second designate operation is to cease processing a signal sent from the digitizer board.

20. The processing method as claimed in claim 16, wherein the second designate operation is to cease receiving a signal sent from the digitizer board.
